(19) United States
(12) Patent Application Publication
(10) Pub. No.: US 2025/0093602 A1
(43) Pub. Date: Mar. 20, 2025

(54) OPTICAL FIBER CABLE

(71) Applicant: SUMITOMO ELECTRIC INDUSTRIES, LTD., Osaka (JP)

(72) Inventors: Fumiaki SATO, Osaka (JP); Yuuki SHIMODA, Osaka (JP); Yutaka HASHIMOTO, Osaka (JP)

(21) Appl. No.: 18/889,602

(22) Filed: Sep. 19, 2024

(30) Foreign Application Priority Data
Sep. 20, 2023 (JP) 2023-152364

(51) Int. Cl. G02B 6/44

(52) U.S. Cl. CPC G02B 6/4429

(57) ABSTRACT

An optical fiber cable includes a cable core that includes a plurality of optical fibers, a sheath that is provided around the cable core, a reinforcing sheet that is embedded in the sheath, and a tensile strength member that is embedded in the sheath. The reinforcing sheet is disposed such that a gap is formed in a part in a circumferential direction of the cable core. The tensile strength member is disposed such that a part of the tensile strength member overlaps a line segment connecting a first end portion and a second end portion of the reinforcing sheet in the circumferential direction.

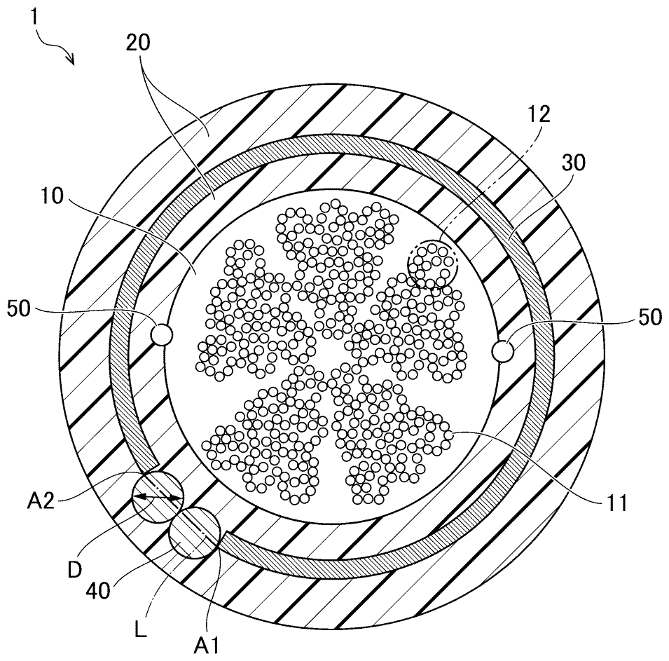

### CROSS-REFERENCE TO RELATED APPLICATION

This application claims priority from Japanese Patent Application No. 2023-152364, filed on Sep. 20, 2023, the entire subject matter of which is incorporated herein by reference.

### TECHNICAL FIELD

The present disclosure relates to an optical fiber cable.

### BACKGROUND

JP2020-106568A describes an optical fiber cable including: a unit that accommodates a plurality of optical fibers; an inner sheath that accommodates the unit; a reinforcing sheet that is disposed around the inner sheath; and an outer sheath that is disposed around the reinforcing sheet.

### SUMMARY

As described in JP2020-106568A, the optical fiber cable including the reinforcing sheet that is disposed around the inner sheath has excellent robustness.

On the other hand, the optical fiber cable described in JP2020-106568A has room for improvement of disassembly properties.

An object of the present disclosure is to provide an optical fiber cable having excellent robustness and disassembly properties at the same time.

An embodiment of the present disclosure provides an optical fiber cable including:
a cable core that includes a plurality of optical fibers;
a sheath that is provided around the cable core;
a reinforcing sheet that is embedded in the sheath; and
a tensile strength member that is embedded in the sheath,
wherein the reinforcing sheet is disposed such that a gap is formed in a part in a circumferential direction of the cable core, and
the tensile strength member is disposed such that a part of the tensile strength member overlaps a line segment connecting a first end portion and a second end portion of the reinforcing sheet in the circumferential direction.

According to the present disclosure, an optical fiber cable having excellent robustness and disassembly properties at the same time can be provided.

### BRIEF DESCRIPTION OF DRAWINGS

The FIGURE is a cross-sectional view illustrating an optical fiber cable according to an embodiment.

### DESCRIPTION OF EMBODIMENTS

### Description of Embodiment of Present Disclosure

First, aspects of the present disclosure will be described.

(1) An optical fiber cable according to one aspect of the present disclosure includes:
a cable core that includes a plurality of optical fibers;
a sheath that is provided around the cable core;
a reinforcing sheet that is embedded in the sheath; and
a tensile strength member that is embedded in the sheath,
in which the reinforcing sheet is disposed such that a gap is formed in a part in a circumferential direction of the cable core, and
the tensile strength member is disposed such that a part of the tensile strength member overlaps a line segment connecting a first end portion and a second end portion of the reinforcing sheet in a circumferential direction.

In the above-described optical fiber cable, by removing the tensile strength member, the optical fiber cable is likely to be disassembled from the gap of the reinforcing sheet. In addition, since the tensile strength member is provided in the gap of the reinforcing sheet in the circumferential direction, robustness is improved in the circumferential direction of the optical fiber cable. As a result, an optical fiber cable having excellent robustness and disassembly properties at the same time can be provided.

(2) In the optical fiber cable according to (1),
in which one or a plurality of the tensile strength members may be provided, and
a total length of diameters of the tensile strength members may be larger than a distance of the line segment connecting the first end portion and the second end portion.

The one or the plurality of tensile strength members are provided, and the total length of diameters of the tensile strength members is larger than the distance of the line segment connecting the first end portion and the second end portion. Therefore, the tensile strength member is likely to be disposed to block the gap of the reinforcing sheet. As a result, robustness is improved in the circumferential direction of the optical fiber cable.

(3) In the optical fiber cable according to (1) or (2),
a plurality of the tensile strength members may be provided.

With the above-described configuration, the plurality of tensile strength members are provided. Therefore, the optical fiber cable is configured such that the plurality of tensile strength members block the gap of the reinforcing sheet. As a result, a required thickness of the sheath in a radial direction can be reduced as compared to a case where one tensile strength member blocks the gap. Therefore, the diameter of the optical fiber cable can be reduced.

(4) In the optical fiber cable according to any one of (1) to (3),
in which a rip cord may be provided between the cable core and the sheath.

Since the rip cord is provided between the cable core and the sheath, the disassembly properties of the optical fiber cable are improved.

(5) In the optical fiber cable according to any one of (1) to (4),
in which a diameter of the tensile strength member may be 1.2 mm or more and 2.4 mm or less.

By setting the diameter of the tensile strength member to be 1.2 mm or more and 2.4 mm or less, the robustness of the optical fiber cable and a reduction in the diameter of the optical fiber cable can be achieved at the same time.

### Details of Embodiment of Present Disclosure

Specific examples of an optical fiber unit and the optical fiber cable according to the embodiment of the present disclosure will be described below with reference to the drawing. The present invention is not limited to these examples and is intended to include any modifications within the scope and meaning equivalent to the terms of the claims.

The FIGURE is a cross-sectional view illustrating an optical fiber cable 1. As illustrated in the FIGURE, the optical fiber cable 1 includes a cable core 10, a sheath 20, a reinforcing sheet 30, a tensile strength member 40, and a rip cord 50.

The cable core 10 includes a plurality of optical fibers 11. Regarding the optical fibers 11 according to the present embodiment, 12 optical fibers are connected in parallel to configure an optical fiber ribbon 12. In addition, a plurality of the optical fiber ribbons are bundled to form a unit, and five units are gathered to configure the cable core 10. In the optical fiber ribbon 12, the optical fibers 11 adjacent to each other may be intermittently connected at predetermined intervals in a longitudinal direction of the optical fiber ribbon 12. The optical fibers 11 may be in the form of individual single cores without configuring the optical fiber ribbon. Each of the optical fibers 11 includes: a glass fiber that includes a core and cladding; and a resin layer that covers the glass fiber. The diameter of the glass fiber is typically about 125 μm. The diameter of the optical fiber 11 is, for example, 180 μm or more and 220 μm or less and, in the present example, is 200 μm.

The sheath 20 is provided around the cable core 10, and covers the cable core 10. The sheath 20 is formed of, for example, a polyethylene resin, a flame-retardant polyethylene resin, or a polyvinyl chloride resin.

The reinforcing sheet 30 is embedded in the sheath 20. The reinforcing sheet 30 is disposed at a thickness center position in the layer of the sheath 20. The reinforcing sheet 30 is disposed in a C-shape in cross-section such that a gap is formed in a part in a circumferential direction of the cable core 10. The reinforcing sheet 30 is formed of, for example, steel or a rigid plastic. The thickness of the reinforcing sheet 30 may be 0.5 mm or more and 1.5 mm or less. In addition, the distance of a line segment L connecting a first end portion A1 and a second end portion A2 may be 2.0 mm or more and 4.6 mm or less. In the present embodiment, the distance of the line segment Lis 3.4 mm.

The tensile strength member 40 is disposed to be embedded in the sheath 20 along the cable core 10. The tensile strength member 40 is formed of, for example, steel or a rigid plastic. In order to make the bending rigidity of the optical fiber cable 1 in the circumferential direction uniform, the thickness, the material, or the like of the reinforcing sheet 30 or the tensile strength member 40 may be adjusted. For example, in order to make the bending rigidity of the optical fiber cable 1 in the circumferential direction uniform, the reinforcing sheet 30 and the tensile strength member 40 may be formed of the same material. A diameter D of the tensile strength member 40 is desirably 1.2 mm or more and 2.4 mm or less. In the present embodiment, for example, the tensile strength member 40 is formed of steel, and the diameter D of the tensile strength member 40 is 1.8 mm. The reinforcing sheet 30 and the tensile strength member 40 may be on the same circumference but do not have to have the same thickness. For example, the diameter of the tensile strength member 40 may be larger than the thickness of the reinforcing sheet 30.

A plurality of the tensile strength members 40 may be provided. In the optical fiber cable 1 according to the present embodiment, two tensile strength members 40 are provided in parallel in the cable circumferential direction. The tensile strength members 40 are desirably disposed together at one position of the sheath 20. As a result, the bending anisotropy of the optical fiber cable 1 can be reduced, and thus the workability of the optical fiber cable 1 is improved.

The tensile strength members 40 are disposed so as to be interposed in the gap formed in the reinforcing sheet 30. Specifically, the tensile strength members 40 are disposed such that a part of the tensile strength members 40 overlaps the line segment L connecting the first end portion A1 and the second end portion A2 of the reinforcing sheet 30 in the cable circumferential direction. In order to make the bending rigidity of the optical fiber cable 1 in the circumferential direction uniform, the reinforcing sheet 30 and the tensile strength member 40 may be disposed on the same circumference.

The total length of the diameters D of the tensile strength members 40 is desirably larger than the distance of the line segment L connecting the first end portion A1 and the second end portion A2. In the present embodiment, the diameter D of the tensile strength member 40 is 1.8 mm, and two tensile strength members 40 are provided. Therefore, the total length of the diameters D of the tensile strength members 40 is 3.6 mm. In addition, the distance of the line segment L connecting the first end portion A1 and the second end portion A2 is 3.4 mm. In this case, the reinforcing sheet 30 and the tensile strength members 40 are disposed such that the gap of the reinforcing sheet 30 is blocked by the tensile strength members 40.

The rip cord 50 is disposed between the cable core 10 and the sheath 20. The rip cords 50 are provided one by one on an inner circumferential surface of the sheath 20 such that the center of the cable core 10 is interposed between the rip cords 50. The rip cord 50 is formed of a resin material such as nylon or polyester.

In the optical fiber cable where the reinforcing sheet is disposed to surround the entire circumference of the cable core, the robustness of the optical fiber cable can be ensured, but time and effort is required to disassemble the optical fiber cable. In addition, when the tensile strength member is provided in the cable core, the diameter of the cable core is likely to increase, and when the tensile strength member is embedded in the sheath, the thickness of the sheath is likely to increase. Therefore, the outer diameter of the optical fiber cable is also likely to increase.

In the above-described optical fiber cable 1, by removing the tensile strength member 40, the optical fiber cable 1 is likely to be disassembled from the gap of the reinforcing sheet 30. In addition, since the tensile strength member 40 is provided in the gap of the reinforcing sheet 30 in the circumferential direction, robustness is improved in the circumferential direction of the optical fiber cable 1. As a result, the optical fiber cable 1 having excellent robustness and disassembly properties at the same time can be provided. In addition, a certain degree of cable rigidity can be ensured with the reinforcing sheet 30, and thus the diameter of the tensile strength member 40 can be relatively reduced. As a result, the optical fiber cable 1 having excellent robustness and disassembly properties at the same time and having a reduced diameter can be provided.

Although the present disclosure has been described in detail with reference to specific embodiments, it will be apparent to those skilled in the art that various changes and modifications can be made without departing from the spirit and scope of the disclosure. In addition, the numbers, positions, shapes, and the like of the components described above are not limited to those of the embodiments and can be changed to numbers, positions, shapes, and the like suitable for implementing the present disclosure.

What is claimed is:

1. An optical fiber cable comprising:
a cable core that includes a plurality of optical fibers;
a sheath that is provided around the cable core;
a reinforcing sheet that is embedded in the sheath; and
a tensile strength member that is embedded in the sheath,
wherein the reinforcing sheet is disposed such that a gap is formed in a part in a circumferential direction of the cable core, and
the tensile strength member is disposed such that a part of the tensile strength member overlaps a line segment connecting a first end portion and a second end portion of the reinforcing sheet in the circumferential direction.

2. The optical fiber cable according to claim 1,
wherein one or a plurality of the tensile strength members are provided, and
a total length of diameters of the tensile strength members is larger than a distance of the line segment connecting the first end portion and the second end portion.

3. The optical fiber cable according to claim 1,
wherein a plurality of the tensile strength members are provided.

4. The optical fiber cable according to claim 2,
wherein a plurality of the tensile strength members are provided.

5. The optical fiber cable according to claim 1,
wherein a rip cord is provided between the cable core and the sheath.

6. The optical fiber cable according to claim 2,
wherein a rip cord is provided between the cable core and the sheath.

7. The optical fiber cable according to claim 1,
wherein a diameter of the tensile strength member is 1.2 mm or more and 2.4 mm or less.

8. The optical fiber cable according to claim 2,
wherein a diameter of the tensile strength member is 1.2 mm or more and 2.4 mm or less.
